(19) United States
(12) Patent Application Publication
(10) Pub. No.: US 2022/0007686 A1
(43) Pub. Date: Jan. 13, 2022

(54) CANNABINOIDS-CONTAINING BEVERAGES

(71) Applicant: YISSUM RESEARCH DEVELOPMENT COMPANY OF THE HEBREW UNIVERSITY OF JERUSALEM LTD., Jerusalem (IL)

(72) Inventors: Elka TOUITOU, Hod Hasharon (IL); Hiba NATSHEH, Jerusalem (IL)

(21) Appl. No.: 17/289,576

(22) PCT Filed: Oct. 31, 2019
(86) PCT No.: PCT/IL2019/051191

§ 371 Date: Apr. 28, 2021

Related U.S. Application Data
(60) Provisional application No. 62/755,484, filed on Nov. 4, 2018.

(51) Int. Cl. A23L 2/52; A23L 2/39

(52) U.S. Cl. CPC A23L 2/52; A23L 2/39

(57) ABSTRACT

Cannabinoids-containing aqueous beverage comprising cannabinoids and phospholipids.

There is an increasingly growing trend to place in the market cannabinoids-containing beverages, to enable consumers to benefit from the advantages that cannabinoids possess. However, cannabinoids are highly lipophilic molecules and therefore cannabinoids-containing aqueous compositions, for example, beverages, are difficult to prepare. Moreover, in general, such beverage products, also known as cannabinoids infused-beverages, require multiple additives or high concentration of additives to enable cannabinoids incorporation thereinto.

Surprisingly, we have discovered that we are able to add cannabinoids to water or water-based beverages and provide cannabinoids-containing beverages by using very small amounts of additives. The important finding is that we can incorporate cannabinoids into aqueous systems, such as beverages, with the aid of surprisingly small amounts of additives, by using a pre-prepared mixture of cannabinoids and phospholipids. To achieve this goal, a suitable mixture consisting of cannabinoids and phospholipids is initially prepared by mechanical mixing. By one exemplary method, on gradual, slow addition of water or water-containing beverage to the pre-prepared cannabinoids/phospholipids mixture under mixing, cannabinoids-containing beverage is produced.

For example, we have found that concentrations of phospholipids as low as 0.0125% or 0.00625% w/v enable the incorporation of 0.0125% cannabinoids into beverages—this being an acceptable cannabinoid concentration in beverages. That is, with the method described herein, only 6.25 mg or 12.5 mg phospholipids are needed to make 100 ml cannabinoids-containing water or cannabinoids-containing soft drinks, with the usually marketed quantity of cannabinoids [beverage cans (300 to 350 ml) available on the market contain around 20 mg cannabidiol (CBD)].

Accordingly, one aspect of the invention is a beverage component comprising, or consisting of, a mixture of one or more cannabinoid(s) and one or more phospholipid(s). By “beverage component” is meant that the cannabinoids/phospholipids mixture is intended to be mixed with a beverage (or beverage ingredients) and is suitable for incorporating cannabinoids into the beverage.

The beverage component of the invention is based on mixtures of cannabinoid(s) with phospholipid(s) obtained by mechanical mixing. The mixtures may be equally proportioned by weight, or the cannabinoid(s) may be the predominant component thereof, that is, mixtures where the weight ratio cannabinoid(s) to phospholipid(s) is in the range from 1:1 to 3:1, for example, 1:1 to 2.5:1, e.g., 1:1 to 2:1, or the phospholipids may be the predominant component, e.g., weight ratio cannabinoid(s) to phospholipid(s) is from 1:1 to 1:2. The phospholipids and cannabinoids are first mixed well together by the methods illustrated in the examples below, e.g., mixing over a period of time, optionally with periodical intermissions, to create a mixture suitable for use as a beverage component; i.e., an intimate mixture in the form of a liquid, viscous liquid, semisolid or a soft mass.

The use of cannabinoids/phospholipids mixtures prepared as described above as a beverage component to incorporate cannabinoids into beverages, forms another aspect of the invention.

The invention also relates to a method for the preparation of cannabinoids-containing beverages, comprising a step of incorporating a cannabinoids/phospholipids mixture as described above into a beverage.

The addition may take place at any stage during the manufacturing process of the beverage. We have found that incorporation of the cannabinoids/phospholipids blend to the beverage can be conveniently achieved after the beverage product has been made; that is, for example by adding slowly with mixing small quantities of the finished beverage to the cannabinoids/phospholipids mixture.

More specifically, the invention also relates to a method for the preparation of cannabinoids-containing beverages, comprising:

providing a beverage component in the form of a pre-prepared mixture of cannabinoids and phospholipids (e.g., obtained by first mixing the phospholipids, then adding the cannabinoids and mixing well together); and
gradually combining said beverage component with a beverage (e.g., by adding a beverage to the cannabinoids/phospholipids mixture under mixing), and optionally homogenizing the so-formed cannabinoids-containing beverage.

The cannabinoid plus phospholipid component may be supplied to the beverage manufacturing process also in the form of a concentrate comprising the cannabinoids/phospholipids mixture and a suitable liquid carrier, usually one that corresponds to the beverage to be produced. Next, the concentrate is diluted by addition with mixing of the rest of the beverage volume. The final formulation could be homogenized.

It can be seen that the method of the invention is readily amenable to large scale production and can be easily incorporated into production lines of beverages manufacturers. A beverage production batch can be simply added to the pre-prepared cannabinoids/phospholipids mixture (either as such or in the form of a concentrate) by operating a downstream blending and homogenizing device. Homogenization can be made by using overhead stirrers, ultrasonic homogenizers and/or high-pressure homogenizers.

Homogenization can take place at various stages of the process, e.g., homogenizing the concentrate, homogenizing the composition formed during dilution/addition, or homogenizing after addition/dilution is completed, to obtain the finished product.

Homogenizers could be of different sizes such as Heidolph Hei Torque value 200 (Heidolph Instruments, Germany), Heidolph RZR 2000 Digital (Heidolph Instruments, Germany), OS20-Pro LCD Digital Overhead Stirrer (Thomas Scientific Inc, USA), OS40-Pro LCD Digital Overhead Stirrer (Thomas Scientific Inc, USA), OS20-S LED Digital Overhead Stirrer (Thomas Scientific Inc, USA), OS40-S LED Digital Overhead Stirrer (Thomas Scientific Inc, USA), High-pressure homogenizer, LV1 Low Volume Microfluidizer® Processor (Microfluidics, USA), M-110P Microfluidizer®: A “Plug and Play” Electric Benchtop Laboratory Homogenizer (Microfluidics, USA), M-110EH-30 Electric-Hydraulic (Microfluidics, USA), M-815 Microfluidizer™ Pilot Scale Processor Series (Microfluidics, USA), M-700 Series (Microfluidics, USA), M-710 Series (Microfluidics, USA), nG7575 range of pilot scale high pressure homogenisers (Homogenising Systems Limited, UK), 085 and 11300 production models—for Ultra High Pressure Homogenization (Homogenising Systems Limited, UK), Sonic-650WT-V2 Ultrasonic processor. (Sonic Series, MRC Ltd, Holon, Israel), SONICS VCX750 Vibra Cell (PRO Scientific Inc, USA), Scientz 950W 0.5-600 ml Ultrasonic Sonicator/Homogenizer (Scientz, China), Q2000 Sonicator (Homogenizers, USA), UIP2000hdT Industrial Ultrasonicator (Hielscher Ultrasound Technology, Germany) and such.

The beverage component that is prepared in advance, may also be packed and stored, ready to be used for ad hoc preparations by an individual consumer. For example, one aspect of the invention is an article of manufacture in the form of a package designed to contain a single dose, or two or more doses, of the cannabinoids/phospholipids mixture, so that the package can be resealed with suitable closure means to enable repeated use. The consumer takes out from the package a metered amount of the mixture, puts it in a suitable vessel, e.g., a mixer and slowly adds the beverage under mixing.

The following ingredients may be included in the beverage component: antioxidants, taste additives, surfactants, color, preservatives, polymers, smell additives, gums, thickeners, terpenes, glycols, glycerol could be added to the compositions. Surfactants may comprise Polysorbates, Tween 80, Tween 20, sugar surfactants, hydrophilic surfactants with high HLB, and taste-masking agents.

Phospholipids for use in the invention are preferably selected from: Phospholipons, Phospholipon 90G, Lipoids, Lipoid 5100, phosphatidylcholine, soy lecithin, egg lecithin, lecithin, lecithin with low content of free fatty acids, sunflower phospholipid (Sunlipons, Sunlipon®90, Sunlipon® 65, Sunlipon® 50.

Cannabinoids for use in the invention are preferably selected from: CBD isolated from plant or synthetic, THC extracted from plant or synthetic, mixture of CBD and THC, CBN, new synthetic derivatives of CBD, terpenes from Cannabis [cannabidiol (CBD); tetrahydrocannabinol (THC); cannabinol (CBN)]. To prepare the compositions of the invention, the cannabinoid compounds, either natural or synthetic, may be utilized in a solid form (for example, an isolated synthetic compound that underwent purification by crystallization), or in the form of an extract.

Drinks to be produced by the invention include water, gaseous water, soda, club soda, soda stream, mineral water from natural sources, purified water, dead sea water, red sea water, mineral water industrial, fruit water, tea, sweet tee, cold and hot drinks, mate drink, ice tea, green tea, Choco, coffee drink, coca, fruit extracts, syrups, decoctions, infusions, milk, soft drinks with or without CO2, lemonade, aromatic waters, smoothies, fruit juice, squeezed fruit juices.

The invention relates to cannabinoids-containing aqueous beverage comprising cannabinoids and phospholipids, preferably from 1 to 20 mg/100 ml cannabinoids (e.g. from 1 to 15 mg/100 ml) and from 1 to 20 mg/100 ml phospholipids (e.g. from 1 to 15 mg/100 ml, for example, from 1 to 10 mg/100 ml). In the finished beverage product, phospholipids/cannabinoids could exist dispersed as nanoparticles with diameter in the range of 50 nm to 900 nm, e.g., 100 nm to 500 nm.

In addition to serving as a component in the beverage industry, the cannabinoids/phospholipids mixtures of the invention may be used to incorporate cannabinoids homogeneously in aqueous compositions for other purposes as well.

### EXAMPLES

| Materials | Abbreviation | Manufacturer |
|---|---|---|
| Phospholipon 90G | PL 90G | Lipoid^{a} |
| Lipoid S100 | | Lipoid^{a} |
| Sunlipon 90 | SL 90 | Perimondo^{b} |
| Propylene glycol | PG | Tamar^{c} |
| Sodium benzoate | | Sigma Aldrich^{c} |
| Cannabidiol, | CBD¹ | Aifame^{d} |
| Obtained by extraction | | |
| from plants, purity 93.7% | | |
| Cannabidiol, synthetic | CBD² | STI Pharmaceuticals ^{e} |
| Tetrahydrocannabinol | THC | BOL Pharma^{c} |

^{a}Germany
^{b}USA
^{c}Israel
^{d}Switzerland
^{e} UK

Beverages

| | | Ingredients (detailed by |
|---|---|---|
| Beverage Brand | Manufacturer | the manufacturer) |
| Neviot Mineral | Neviot Galilee | Natural mineral water |
| water | Teva, Israel | |
| Mey Eden | Eden Springs, | Natural mineral water - |
| Mineral water | Israel | |
| Tapuzina | Jafora Tabori, | Water, sugar, orange juice, |
| orange | Israel | citric acid, guar gum, acacia |
| | | gum, kayara gum, sodium |
| | | citrate, potassium citrate, |
| | | ascorbic acid, flavoring and |
| | | coloring agents. |
| Mirinda | Pepsico, Israel | Water, sugar, carbon dioxide, |
| (orange | | acacia gum, glycerol ester of |
| flavored) | | gum rosin, sodium benzoate, |
| | | vitamin C, citric acid, flavor- |
| | | ing and coloring agents. |
| Prigat | Prigat, Israel | Water, grapefruit juice, |
| (Grapefruit | | fructose, sugar, citric acid, |
| soft drink) | | potassium citrate, pectin, |
| | | acacia gum, vitamin C, and |
| | | flavoring agents. |
| Topuzina | Jafora Tabori, | Water, apple juice, maleic acid, |
| (Transparent | Israel | potassium citrate, ascorbic acid |
| apple soft | | and flavoring agents. |
| drink) | | |
| Fanta | Coca- Cola | Water, sugar, fructose, carbon |
| | company, Israel | dioxide, citric acid, sodium |
| | | citrate, beta carotene, acacia |
| | | gum, sucrose acetate isobutyrate, |
| | | ascorbic acid, and flavoring |
| | | agents. |
| Red Bull | Red Bull, | Water, sugar, glucose, citric |
| energy drink | Austria | acid, carbon dioxide, taurine, |
| | | sodium bicarbonate, magnesium |
| | | carbonate, caffeine, Vitamins: |
| | | niacin, pantothenic acid (B5), |
| | | pyridoxine, riboflavin, cobalamin |
| | | (B12), flavoring agents, and |
| | | riboflavin coloring agent |
| Gatorade | Pepsico, Italy | Water, sugar, maltodextrin, |
| Orange | | citric acid, sodium citrate, |
| | | sodium chloride, potassium |
| | | phosphate, glycol ester of wood |
| | | rosin, acacia gum, ascorbic acid, |
| | | flavoring and coloring agents, |
| | | magnesium oxide, acesulfame |
| | | potassium, sucralose, beta |
| | | carotene, tocopheryl acetate |
| Gatorade | Pepsico, Italy | Water, sugar, maltodextrin, citric |
| Blue | | acid, sodium citrate, sodium |
| | | chloride, potassium phosphate, |
| | | glycol ester of wood rosin, acacia |
| | | gum, ascorbic acid, flavoring and |
| | | coloring agents, magnesium oxide, |
| | | acesulfame potassium, sucralose, |
| | | brilliant blue fcf, tocopheryl |
| | | acetate |
| Gatorade | Pepsico, Italy | Water, sugar, maltodextrin, citric |
| Red orange | | acid, sodium citrate, sodium |
| | | chloride, potassium phosphate, |
| | | glycol ester of wood rosin, acacia |
| | | gum, ascorbic acid, flavoring and |
| | | coloring agents, magnesium oxide, |
| | | acesulfame potassium, sucralose, |
| | | beta carotene, tocopheryl acetate |
| Bavaria 0.0% | Bavaria, The | Natural mineral water, barley |
| Alcohol Malt | Netherlands | malt, maltose and hops. |
| Drink | | |
| Nestle Bottled | Nestle, Jordan | Natural mineral water |
| Drinking Water | | |
| Stella Artois | Stella Artois, | Water, barely malt, corn, carbon |
| 5% Alcohol | Belgium | dioxide. |
| Starbucks | Pepsico, USA | Coffee, water, reduced fat milk, |
| chilled | | sugar, maltodextrin, pectin, |
| coffee drink | | ascorbic acid. |

### Example 1

| | | |
|---|---|---|
| CBD¹ | 10 | mg |
| PL 90G | 10 | mg |
| Mineral Water | 80 | ml |

Preparation Method:

The phospholipid is kneaded well, and then mixed with CBD for about one hour with intermittent mixing. The process is carried out at room temperature or at the usual ambient temperature. Then, the Mineral Water is added gradually through mixing. The obtained dispersion is further homogenized in ultrasound or high-pressure food homogenizer.

### Example 2

| | | |
|---|---|---|
| CBD¹ | 10 | mg |
| PL 90G | 10 | mg |
| Mirinda | 80 | ml |

### Preparation Method:

PL90G is well kneaded and then mixed with CBD for 60 minutes with intermittent mixing. The process is carried out at room temperature or at the usual ambient temperature. Then the Mirinda is added gradually through mixing. The obtained drink is homogeneous. If wanted, the product can be further homogenized using an ultrasound or high-pressure food apparatus.

### Example 3

| | | | % w/v | |
|---|---|---|---|---|
| CBD¹ | 10 | mg | 0.0125 | g |
| PL 90G | 5 | mg | 0.00625 | g |
| Mineral Water | 80 | ml | 100 | ml |

### Preparation Method:

Phospholipid is kneaded well, then mixed with CBD for about an hour with intermittent mixing. The process can be carried out at room temperature or at the usual ambient temperature. Then the Mineral Water is added gradually through mixing. The obtained dispersion is further homogenized using a food homogenizer.

### Example 4

| | | | % w/v | |
|---|---|---|---|---|
| CBD¹ | 10 | mg | 0.0125 | g |
| PL 90G | 5 | mg | 0.00625 | g |
| Mirinda | 80 | ml | 100 | ml |

### Preparation Method:

PL was kneaded well then mixed with CBD for 1 hour with intermittent mixing. Then the Mirinda was added gradually through mixing. The process is carried out at room temperature or at the usual ambient temperature. The obtained drink is homogeneous. If wanted, it can be further homogenized using a food apparatus.

### Example 5

| | | | % w/v | |
|---|---|---|---|---|
| CBD¹ | 10 | mg | 0.0125 | g |
| THC | 2 | mg | 0.0025 | g |
| Lipoid S100 | 7 | mg | 0.00875 | g |
| Mirinda | 80 | ml | 100 | ml |

### Preparation Method for 100 ml Drink:

PL is kneaded well then mixed with CBD and THC for 40 minutes with intermittent mixing. Then 20 ml Mirinda is added gradually through mixing to make a concentrate. The obtained concentrate dispersion is diluted by slow and gradual addition mixing with the remaining volume of the beverage. The composition may further be homogenized using various food homogenizers.

Phospholipids and cannabinoids are thermosensitive. No need to heat or use of heat to prepare the cannabinoid mixture component.

### Example 6

| | | |
|---|---|---|
| CBD¹ | 10 | mg |
| PL 90G | 10 | mg |
| Mineral Water | 80 | ml |

Preparation Method:

Phospholipid was worked well and then mixed with CBD with intermittent mixing. Then, ten ml Mineral Water were added gradually through mixing in a mortar and pestle. The obtained liquid was transferred into a glass vessel to which the remaining mineral water volume was added gradually through mixing using an overhead stirrer at 700 rpm (Heidolph RZR 2000 Digital, Heidolph Instruments, Germany). The obtained composition was further homogenized for 10 cycles in a high-pressure homogenizer (M-110P Microfluidizer®: A “Plug and Play” Electric Benchtop Laboratory Homogenizer, Microfluidics, USA).

### Example 7

| | | |
|---|---|---|
| CBD¹ | 10 | mg |
| PL 90G | 10 | mg |
| Mirinda | 80 | ml |

### Preparation Method:

PL 90G was well mixed and then mixed with CBD intermittently. Ten ml Mirinda were added gradually through mixing in a mortar and pestle. The obtained liquid was transferred into a glass vessel to which the remaining Mirinda volume was added gradually through mixing with an overhead stirrer at 700 rpm (Heidolph RZR 2000 Digital, Heidolph Instruments, Germany). The obtained composition was further homogenized for 10 cycles in a high-pressure homogenizer (M-110P Microfluidizer®: A “Plug and Play” Electric Benchtop Laboratory Homogenizer, Microfluidics, USA).

### Example 8

| | | |
|---|---|---|
| CBD¹ | 10 | mg |
| PL 90G | 5 | mg |
| Mineral Water | 80 | ml |

### Preparation Method:

Phospholipid was intermittently mixed with CBD for about one hour. A part of Mineral Water was added gradually. The remaining Mineral Water volume was then added gradually through mixing at a high shear rate. The obtained composition was homogenized using an ultrasonic processor and then in a high-pressure homogenizer.

### Example 9

| | | |
|---|---|---|
| CBD¹ | 10 | mg |
| PL 90G | 5 | mg |
| Mirinda | 80 | ml |

### Preparation Method:

Phospholipid was mixed intermittently with CBD for about 1 hour. Then, ten ml Mirinda were added gradually through mixing in a mortar and pestle. The obtained liquid was transferred into a glass vessel to which the remaining Mirinda volume was added gradually through mixing with an overhead stirrer at 700 rpm (Heidolph RZR 2000 Digital, Heidolph Instruments, Germany). The obtained composition was homogenized using an ultrasonic processor (Scientz 950W Ultrasonic Sonicator/Homogenizer, Scientz, China) for 10 min and then further homogenized for 10 cycles in a high-pressure homogenizer (M-110P Microfluidizer®: A “Plug and Play” Electric Benchtop Laboratory Homogenizer, Microfluidics, USA).

### Example 10

| | | |
|---|---|---|
| CBD¹ | 1 | mg |
| Sunlipon ® 90 | 1 | mg |
| Nestle Water | 17.5 | ml |

### Preparation Method:

Phospholipid was worked well, then intermittently mixed with CBD. The process was carried out at room temperature. Five hundred microliters Nestle Water were added gradually through mixing in a mortar and pestle. The obtained liquid was added to the remaining Nestle Water volume through mixing. The obtained composition was sonicated at a power rate of 40% (SONICS VCX750 Vibra Cell, PRO Scientific Inc, USA) then homogenized 5 times in a high-pressure homogenizer under 20000 psi (LV1 Low Volume Microfluidizer® Processor (Microfluidics, USA).

### Example 11

a. Beverage Concentrate

| | | |
|---|---|---|
| CBD¹ | 3 | mg |
| Sunlipon ® 90 | 3 | mg |
| Nestle Water | 5.25 | ml |

### Preparation Method:

Phospholipid was worked well, then mixed with CBD for about one hour with intermittent mixing. The process was carried out at room temperature. One ml Nestle Water was added gradually through mixing in a mortar and pestle, then the obtained liquid was transferred into a glass vessel to which the remaining Nestle Water volume was added through mixing at 800 rpm with an overhead stirrer (Heidolph Hei Torque value 200, Heidolph Instruments, Germany). The mixing was continued for another 10 min. The obtained composition was further processed by an ultrasonic apparatus at 50% power ratio for 10 min (Sonic 650WT-V2, Sonic Series, MRC LTD, Israel). After 1 hour, the composition was homogenized 15 times in a high-pressure homogenizer under 20000 psi (LV1 Low Volume Microfluidizer® Processor (Microfluidics, USA).

This concentrate Composition can be stored for further use.

b. Beverage Composition Using the Concentrate in Part a.

| | | |
|---|---|---|
| concentrate composition part a | 2 | ml |
| Nestle Water | 15 | ml |

### Preparation Method:

Two ml of the concentrate were mixed with 15 ml Nestle Water and shaken for a few minutes.

### Example 12

| | | |
|---|---|---|
| CBD² | 1 | mg |
| Sunlipon ® 90 | 1 | mg |
| Gatorade carrot | 17.5 | ml |

### Preparation Method:

Phospholipid was worked well then mixed with CBD intermittently for 10 min. A homogenous liquid was obtained. Five hundred microliters Gatorade carrot were then added in portions of 100 μl through mixing in a mortar and pestle. The liquid was homogenized using an ultrasonic processor at 50% power rate for 10 min (Sonic-650WT-V2, Sonic Series, MRC Ltd, Israel). Then this liquid was added to the remaining Gatorade carrot volume through mixing with an overhead stirrer at 800 rpm (Heidolph Hei Torque value 200, Heidolph Instruments, Germany). The mixing was continued for another 10 min.

### Example 13

| | | |
|---|---|---|
| CBD² | 1 | mg |
| Sunlipon ® 90 | 1 | mg |
| Gatorade orange | 17.5 | ml |

### Preparation Method:

Phospholipid is worked well, then mixed with CBD. A homogenous liquid is obtained. Gatorade orange is then added in portions through mixing in a mortar apparatus, then this liquid is homogenized using ultrasonic processor. The sonicated liquid is added to the remaining Gatorade orange volume through mixing. The mixing is continued for another few minutes.

### Example 14

| | | |
|---|---|---|
| CBD² | 1 | mg |
| Sunlipon ® 90 | 1 | mg |
| Gatorade red orange | 17.5 | ml |

### Preparation Method:

Phospholipid was worked well then mixed with CBD intermittently for 10 min. A homogenous liquid was obtained. Five hundred microliters Gatorade red orange were then added in portions of 100 μl through mixing in a mortar and pestle. Then this liquid was homogenized using an ultrasonic processor for 10 min at 50% power rate (Sonic-650WT-V2, Sonic Series, MRC Ltd, Israel). The sonicated liquid was added to the remaining Gatorade red orange volume through mixing with an overhead stirrer at 800 rpm (Heidolph Hei Torque value 200, Heidolph Instruments, Germany). The mixing was continued for another 10 min.

### Example 15

| | | |
|---|---|---|
| CBD² | 1 | mg |
| Sunlipon ® 90 | 1 | mg |
| Gatorade blue | 17.5 | ml |

### Preparation Method:

Phospholipid was worked well, then mixed with CBD intermittently for 10 min, a homogenous liquid was obtained. Gatorade blue was then added in portions through mixing in a mortar apparatus. The liquid was then homogenized using an ultrasonic processor. The sonicated liquid was added to the Gatorade blue remaining volume through mixing. The mixing was continued for short time.

### Example 16

| | | |
|---|---|---|
| CBD¹ | 2 | mg |
| PL90G | 2 | mg |
| Prigat (Grapefruit soft drink) | 35 | ml |

### Preparation Method:

Phospholipid was worked well, then mixed with CBD intermittently for about one hour. A homogenous liquid was obtained. Ten ml Prigat (Grapefruit soft drink) were then added gradually through mixing in a mortar apparatus, then the obtained liquid was transferred to the remaining Prigat (Grapefruit soft drink) volume gradually through mixing. The composition was further homogenized using an ultrasonic processor for 10 min.

### Example 17

| | | |
|---|---|---|
| CBD¹ | 2 | mg |
| PL90G | 2 | mg |
| Fanta | 35 | ml |

### Preparation Method:

Phospholipid was worked in a mortar then mixed with CBD intermittently for about 60 minutes. A viscous liquid was obtained. Ten ml Fanta were then added gradually through mixing, then the obtained liquid was transferred into a glass vessel to which the remaining Fanta volume was added gradually through mixing with an overhead stirrer at 700 rpm (Heidolph RZR 2000 Digital, Heidolph Instruments, Germany). The composition was further homogenized using an ultrasonic processor for 10 min at 30% power rate (Sonic-650WT-V, Sonic Series, MRC Ltd, Israel).

### Example 18

| | | |
|---|---|---|
| CBD² | 1 | mg |
| Sunlipon ® 90 | 0.75 | mg |
| Fanta | 17.5 | ml |

### Preparation Method:

The phospholipid was mixed in a mortar, then mixed with CBD intermittently for 10 min. A small volume of Fanta was added through mixing. Then this liquid was homogenized using an ultrasonic processor for 10 min at 50% power rate (Sonic-650WT-V, Sonic Series, MRC Ltd, Israel). The sonicated liquid was added to the remaining Fanta volume through mixing at 800 rpm with an overhead stirrer (Heidolph Hei Torque value 200, Heidolph Instruments, Germany). The mixing was continued for another 10 min.

### Example 19

| | | |
|---|---|---|
| CBD¹ | 2 | mg |
| PL90G | 2 | mg |
| Grapefruit soft drink (Prigat) | 35 | ml |

### Preparation Method:

The phospholipid was mixed well in a mortar, then mixed with CBD intermittently for about fifty minutes. A liquid was obtained. Ten ml of grapefruit soft drink were then added gradually through mixing. The obtained liquid was further homogenized for about ten minutes using an ultrasonic processor at 70% power rate (Sonic-650WT-V2, Sonic Series, MRC Ltd, Israel). The remaining soft drink volume was added gradually through mixing at 700 rpm with the Heidolph overhead stirrer. The mixing was continued for another few minutes.

### Example 20

| | | |
|---|---|---|
| CBD¹ | 1 | mg |
| PL90G | 1 | mg |
| PG | 2 | mg |
| Red Bull | 17.5 | ml |

### Preparation Method:

The Phospholipid was mixed in a mortar then mixed with CBD intermittently for about 65 minutes. A liquid was obtained. Then PG was added and mixed well. Two ml Red Bull were then added gradually through mixing. The liquid was further homogenized using an ultrasonic processor. The remaining Red Bull volume was added gradually through mixing at 700 rpm with an overhead stirrer (Heidolph Hei Torque value 200, Heidolph Instruments, Germany). The mixing was continued for another five minutes.

### Example 21 (Comparative)

| | | |
|---|---|---|
| CBD¹ | 2 | mg |
| Fanta | 35 | ml |

### Preparation Method:

CBD was placed and mixed in a mortar. Ten ml Fanta were added gradually through mixing, then the liquid was transferred into a glass vessel to which the remaining Fanta volume was added gradually through mixing at 700 rpm with an overhead stirrer (Heidolph RZR 2000 Digital, Heidolph Instruments, Germany). The obtained liquid was not homogenous. It was then processed for 10 min using an ultrasonic apparatus at 50% power rate (Sonic-650WT-V2, Sonic Series, MRC Ltd, Israel).

The resulted liquid was not homogenous, CBD particles were observed immediately after preparation.

### Example 22 (Beverage Concentrate)

| | | |
|---|---|---|
| CBD¹ | 3 | mg |
| PL 90G | 3 | mg |
| Sodium benzoate | 30 | mg |
| Fanta | 1.5 | ml |

### Preparation Method:

The phospholipid was mixed well in a mortar, then mixed with CBD intermittently for about 60 minutes. A liquid was obtained. Fanta was then added in portions through mixing. Then Sodium benzoate was added with mixing. The composition was homogenized using an ultrasonic processor.

### Example 23 (Beverage Concentrate)

| | | |
|---|---|---|
| CBD¹ | 3 | mg |
| PL 90G | 3 | mg |
| Fanta | 1.5 | ml |

### Preparation Method:

The phospholipid was worked well in a mortar, then mixed with CBD intermittently for 1 hour. A liquid was obtained. Fanta was then added in portions through mixing. The composition was then homogenized using an ultrasonic processor.

### Example 24

| | | |
|---|---|---|
| CBD¹ | 1 | mg |
| Sunlipon ® 90 | 1 | mg |
| Mirinda | 17.5 | ml |

### Preparation Method:

The phospholipid was worked well in a mortar, then mixed with CBD intermittently. A liquid was obtained. Five hundred microliters Mirinda were then added in portions of 100 μl through mixing. Then the liquid was homogenized using an ultrasonic processor for 10 min (Sonic-650WT-V2, Sonic Series, MRC Ltd, Israel) at 50% power rate. The sonicated liquid was added to the remaining Mirinda volume through mixing at 800 rpm with an overhead stirrer (Heidolph Hei Torque value 200, Heidolph Instruments, Germany). The mixing was continued for another few minutes.

### Example 25

| | | |
|---|---|---|
| CBD² | 1 | mg |
| Sunlipon ® 90 | 1 | mg |
| Fanta | 17.5 | ml |

### Preparation Method:

The phospholipid was mixed well in a mortar, then mixed with CBD intermittently for 15 min. A liquid was obtained. Five hundred microliters Fanta were then added in portions of 100 through mixing. The obtained liquid was homogenized 10 min in an ultrasonic processor, at 50% power rate (Sonic-650WT-V2, Sonic Series, MRC Ltd, Israel). The sonicated liquid was added to the remaining Fanta volume through mixing at 800 rpm with an overhead stirrer (Heidolph Hei Torque value 200, Heidolph Instruments, Germany). The mixing was continued for another 10 minutes.

### Example 26

| | | |
|---|---|---|
| CBD² | 2 | mg |
| Sunlipon ® 90 | 2 | mg |
| Grapefruit soft drink (Prigat) | 35 | ml |

### Preparation Method:

Sunlipon® 90 was mixed well in a mortar and pestle, then mixed with CBD intermittently for 10 min. A homogenous liquid was obtained. Five hundred microliters Prigat were then added in portions through mixing. Then the liquid was homogenized using an ultrasonic processor. The sonicated liquid was added to the remaining Prigat volume through mixing with an overhead stirrer (Heidolph Hei Torque value 200, Heidolph Instruments, Germany). The mixing was continued for another few minutes.

### Example 27

| | | |
|---|---|---|
| CBD² | 1 | mg |
| Sunlipon ® 90 | 1 | mg |
| Tapuzina transparent apple soft drink | 17.5 | ml |

### Preparation Method:

Sunlipon® 90 was mixed well in a mortar, then mixed with CBD intermittently for minutes. A liquid was obtained. Five hundred microliters Tapuzina transparent apple soft drink were then added in portions through mixing. Then the liquid was homogenized using an ultrasonic processor. The sonicated liquid was added to the remaining soft drink volume through mixing with an overhead stirrer. The mixing was continued for another few minutes.

### Example 28

| | | |
|---|---|---|
| CBD² | 1 | mg |
| Sunlipon ® 90 | 0.75 | mg |
| Gatorade orange | 17.5 | ml |

### Preparation Method:

The phospholipid was mixed well in a mortar, then mixed with CBD intermittently for 15 minutes. A liquid was obtained. Five hundred microliters Gatorade orange were then added in portions through mixing. Then the liquid was homogenized ten minutes using an ultrasonic processor. The sonicated liquid was added to the remaining Gatorade orange volume through mixing. The mixing was continued for about ten minutes

### Example 29

| | | |
|---|---|---|
| CBD² | 1 | mg |
| Sunlipon ® 90 | 0.75 | mg |
| Gatorade blue | 17.5 | ml |

### Preparation Method:

Sunlipon® 90 was mixed well, then mixed with CBD intermittently for about 20 minutes. A liquid was obtained. A small amount of Gatorade blue was then added in portions through mixing. Then the liquid was homogenized using an ultrasonic processor. The sonicated liquid was added to the remaining Gatorade blue volume through mixing.

### Example 30

a. Beverage Concentrate

| | | |
|---|---|---|
| CBD¹ | 2 | mg |
| Sunlipon ® 90 | 2 | mg |
| Tapuzina transparent apple soft drink | 3.5 | ml |

### Preparation Method:

The phospholipid was worked well in a mortar, then mixed with CBD for about one hour with intermittent mixing. The process was carried out at room temperature. One ml Tapuzina was added gradually through mixing, then the obtained liquid was transferred into a glass vessel to which the remaining Tapuzina was added gradually through mixing with an overhead stirrer. The mixing was continued for another 10 min. The obtained composition was further homogenized 5 times in a high-pressure homogenizer under 20000 psi (LV1 Low Volume Microfluidizer® Processor (Microfluidics, USA).

The concentrate composition can be stored and used occasionally.

b. Beverage Composition Using the Concentrate in Part a.

| | | |
|---|---|---|
| concentrate composition part a | 2 | ml |
| Tapuzina transparent apple soft | 15 | ml |

### Preparation Method:

Two ml of concentrate were mixed with 15 ml Tapuzina and vigorously shaken.

### Example 31

a. Beverage Concentrate

| | | |
|---|---|---|
| CBD¹ | 2 | mg |
| Sunlipon ® 90 | 2 | mg |
| Red Bull | 3.5 | ml |

### Preparation Method:

The phospholipid was mixed well in a mortar, then mixed with CBD for about one hour with intermittent mixing. The process was carried out at room temperature. One ml Red Bull was added gradually through mixing, then the obtained liquid was transferred into a vessel to which the remaining Red Bull volume was added through mixing. The mixing was continued for 10 min. The obtained composition was further homogenized 5 times in a high-pressure homogenizer.

The concentrate composition can be stored for further use.

b. Beverage Composition Using the Concentrate in Part a.

| | | |
|---|---|---|
| concentrate composition part a | 2 | ml |
| Red Bull | 15 | ml |

### Preparation Method:

Two ml of concentrate were mixed with 15 ml Red Bull and shaken.

### Example 32

| | | |
|---|---|---|
| CBD¹ | 2 | mg |
| PL90G | 2 | mg |
| Tapuzina orange | 35 | ml |

### Preparation Method:

The phospholipid was mixed well, then mixed with CBD intermittently for 1 hour. A homogenous liquid was obtained. Ten ml Tapuzina orange were then added gradually through mixing. The remaining Tapuzina orange volume was added gradually through mixing. The composition was further homogenized using an ultrasonic processor.

### Example 33

| | | |
|---|---|---|
| CBD¹ | 2 | mg |
| PL90G | 1 | mg |
| Fanta | 35 | ml |

### Preparation Method:

The phospholipid was mixed well in a mortar, then mixed with CBD intermittently for 1 hour. A homogenous liquid was obtained. Ten ml Fanta were then added gradually through mixing. The liquid was further homogenized using an ultrasonic processor for 10 min (Sonic-650WT-V2, Sonic Series, MRC Ltd, Israel) at 70% power rate. The remaining Fanta volume was added gradually through mixing at 700 rpm with an overhead stirrer (Heidolph RZR 2000 Digital, Heidolph Instruments, Germany). The mixing was continued for additional 5 min.

### Example 34

| | | |
|---|---|---|
| CBD¹ | 1 | mg |
| PL90G | 1 | mg |
| Sodium benzoate | 10 | mg |
| Fanta | 17.5 | ml |

### Preparation Method:

The phospholipid is mixed well in a mortar, then mixed with CBD intermittently for about one hour. A liquid is formed. Ten ml Fanta are then added gradually through mixing. Then Sodium benzoate is added with mixing. This liquid is further homogenized using an ultrasonic processor. The remaining Fanta volume is added gradually through mixing.

### Example 35

| | | |
|---|---|---|
| CBD¹ | 1 | mg |
| Sunlipon ® 90 | 1 | mg |
| Bavaria 0.0% Alcohol | 17.5 | ml |

### Preparation Method:

The phospholipid was mixed well in a mortar, then mixed with CBD for about 1 hour with intermittent mixing. The process was carried out at room temperature. Five hundred microliters Bavaria 0.0% Alcohol were added gradually through mixing. The obtained liquid was added to the remaining Bavaria 0.0% Alcohol volume through mixing at 800 rpm with an overhead stirrer (Heidolph Hei Torque value 200, Heidolph Instruments, Germany). The mixing was continued for another 10 min. The obtained composition was further homogenized 5 times in a high-pressure homogenizer under 20000 psi (LV1 Low Volume Microfluidizer® Processor (Microfluidics, USA).

### Example 36

| | | |
|---|---|---|
| CBD¹ | 1 | mg |
| Sunlipon ® 90 | 1 | mg |
| Stella Artois 5% Alcohol | 17.5 | ml |

### Preparation Method:

Sunlipon® 90 was mixed well in a mortar, then mixed with CBD for about one hour with intermittent mixing. The process was carried out at room temperature. Five hundred microliters Stella Artois 5% Alcohol were added gradually through mixing. The obtained liquid was added to the remaining Stella Artois 5% Alcohol volume through mixing. The mixing was continued for a few minutes. The obtained composition was further homogenized in a high-pressure homogenizer.

### Example 37

| | | |
|---|---|---|
| CBD¹ | 1 | mg |
| Sunlipon ® 90 | 1 | mg |
| Starbucks chilled coffee drink | 17.5 | ml |

### Preparation Method:

Sunlipon® 90 was mixed well, then mixed with CBD for about one hour with intermittent mixing. The process was carried out at room temperature. Five hundred microliters Starbucks chilled coffee drink were added gradually through mixing. This liquid was added to the remaining Starbucks chilled coffee drink volume through mixing. The obtained composition was further homogenized in a high-pressure homogenizer.

### Example 38

| | | |
|---|---|---|
| CBD¹ | 1 | mg |
| Sunlipon ® 90 | 1 | mg |
| Red Bull | 17.5 | ml |

### Preparation Method:

The phospholipid was mixed well, then mixed with CBD for about one hour with intermittent mixing. The process was carried out at room temperature. Five hundred microliters Red Bull were added gradually through mixing. This liquid was added to the remaining Red Bull volume through mixing with an overhead stirrer (Heidolph Hei Torque value 200, Heidolph Instruments, Germany). The mixing was continued for another 10 min. The obtained composition was further homogenized 10 times in a high-pressure homogenizer under 20000 psi (LV1 Low Volume Microfluidizer® Processor (Microfluidics, USA).

### Example 39

| | | |
|---|---|---|
| CBD¹ | 3 | mg |
| Sunlipon 90 | 2 | mg |
| Fanta | 35 | ml |

### Preparation Method:

The phospholipid was mixed well in a mortar, then further mixed with CBD intermittently for about one hour. A liquid was obtained. Fanta was then added gradually to the obtained liquid through mixing. The composition was further homogenized using an ultrasonic processor.

### Example 40

| | | |
|---|---|---|
| CBD² | 1 | mg |
| Sunlipon ® 90 | 0.75 | mg |
| Fanta | 18 | ml |

### Preparation Method:

The phospholipid was mixed in a mortar with pestle, then mixed with CBD intermittently for 10 min. A homogenous liquid was obtained. Five hundred microliters of Fanta were then added in portions of 100 μl through mixing. Then this liquid was homogenized for 10 min using the ultrasonic processor Sonic-650WT-V, Sonic Series, MRC Ltd, Israel, at 50% power rate. The sonicated liquid was added to the remaining Fanta volume through mixing at 800 rpm with an overhead stirrer (Heidolph Hei Torque value 200, Heidolph Instruments, Germany). The mixing was continued for another 15 min.

### Example 41

| | | |
|---|---|---|
| CBD² | 30 | g |
| Sunlipon ® 90 | 25 | g |
| Fanta | 35 | L |

### Preparation Method:

Sunlipon® is mixed in a mortar or grinder for about one hour, then mixed with CBD intermittently for another hour. A liquid is obtained. A part of the Fanta is then added gradually through mixing. The obtained liquid can be homogenized using an ultrasonic processor. The sonicated liquid is then added to the remaining Fanta volume through mixing at a high sheer rate. The mixing is continued for another 20 minutes.

### Example 42

| | | |
|---|---|---|
| CBD² | 1 | mg |
| Sunlipon ® 90 | 1 | mg |
| Mirinda | 17.5 | ml |

### Preparation Method:

Phospholipid was worked well then mixed with CBD intermittently for 10 min. A liquid was obtained. The liquid was added to Mirinda and homogenized using an ultrasonic processor. The homogenized liquid was further mixed with an overhead stirrer at a high sheer rate. The mixing was continued for another 10 min. The obtained composition was further homogenized using a high-pressure homogenizer.

### Example 43

| | | |
|---|---|---|
| CBD² | 1.5 | mg |
| Sunlipon ® 90 | 1.5 | mg |
| Mirinda | 17.5 | ml |

### Preparation Method:

Phospholipid was worked well then mixed with CBD intermittently for 10 min. A homogenous liquid was obtained. The liquid was added to Mirinda and homogenized using an ultrasonic processor. The obtained composition was further homogenized using a high-pressure homogenizer.

### Example 44

| | | |
|---|---|---|
| CBD² | 5 | mg |
| Sunlipon ® 90 | 5 | mg |
| Mirinda | 35 | ml |

### Preparation Method:

Phospholipid was worked well then mixed with CBD intermittently for 10 min. A homogenous liquid was obtained. The liquid was added to Mirinda and homogenized using an ultrasonic processor at 50% power rate for 10 min (Sonic-650WT-V2, Sonic Series, MRC Ltd, Israel). The homogenized liquid was further mixed for 10 min with an overhead stirrer at 800 rpm (Heidolph Hei Torque value 200, Heidolph Instruments, Germany). The obtained composition was further homogenized 5 times in a high-pressure homogenizer under 20000 psi (LV1 Low Volume Microfluidizer® Processor (Microfluidics, USA).

### Example 45

| | | |
|---|---|---|
| CBD² | 3 | mg |
| Sunlipon ® 90 | 3 | mg |
| Mirinda | 35 | ml |

### Preparation Method:

Phospholipid was worked well then mixed with CBD intermittently for 10 min. A homogenous liquid was obtained. The liquid was added to Mirinda and homogenized for 10 min using an ultrasonic processor at a power rate of 40% (SONICS VCX750 Vibra Cell, PRO Scientific Inc, USA).

The obtained composition was further homogenized 5 times in a high-pressure homogenizer under 20000 psi (LV1 Low Volume Microfluidizer® Processor (Microfluidics, USA).

### Example 46

| | | |
|---|---|---|
| CBD² | 30 | g |
| Sunlipon ® 90 | 25 | g |
| Mirinda | 35 | L |

### Preparation Method:

Sunlipon® is mixed in a mortar or grinder for about one hour, then mixed with CBD intermittently for another hour. A liquid is obtained. A part of Mirinda is added gradually through mixing. The obtained liquid is homogenized using an ultrasonic processor. The sonicated liquid is then added to the remaining volume of Mirinda through mixing at a high sheer rate. The mixing is continued for additional 30 minutes.

1. Cannabinoids-containing aqueous beverage comprising cannabinoids and phospholipids.

2. The cannabinoids-containing beverage of claim 1, comprising:
from 1 to 20 mg/100 ml cannabinoids; and
from 1 to 20 mg/100 ml phospholipids.

3. A method for the preparation of cannabinoids-containing beverages of claim 1, comprising a step of incorporating a pre-prepared cannabinoids/phospholipids mixture into an aqueous beverage.

4. A method for the preparation of cannabinoids-containing beverages according to claim 3, comprising:
providing a beverage component in the form of a well-mixed mixture of cannabinoids and phospholipids; and
gradually combining a beverage and the cannabinoids/phospholipids mixture under mixing, and optionally homogenizing the so-formed cannabinoids-containing beverage.

5. A method according to claim 3, wherein incorporation of the cannabinoids/phospholipids mixture into the beverage is in the form of a liquid concentrate comprising said cannabinoids/phospholipids mixture and a liquid carrier corresponding to the beverage to be produced.

6. A method according to claim 5, comprising dilution of the concentrate by addition with mixing of the rest of the beverage volume, following which the resulting composition is optionally homogenized to afford the finished beverage.

7. A method according to claim 5, comprising addition of the concentrate into the rest of the beverage volume with mixing, following which the resulting composition is optionally homogenized to afford the finished beverage.

8. A method according to claim 3, comprising homogenizing the concentrate, homogenizing the composition formed during dilution/addition, and/or homogenizing after addition/dilution is completed.

9. A method according to claim 8, wherein homogenization is achieved by one or more of the following: an overhead stirrer, ultrasonic homogenizer and/or high-pressure homogenizer.

10. (canceled)

11. The method of claim 3, wherein the cannabinoids/phospholipids mixture is a liquid mixture.

12. Cannabinoids-containing liquid concentrate for beverage manufacture, comprising cannabinoids/phospholipids mixture in a liquid carrier consisting of said beverage.

13. The concentrate of claim 12, wherein the concentration of the cannabinoids/phospholipids mixture in the concentrate is not less than 50% w/v.

14. Beverage component which is a well-mixed, pre-prepared mixture consisting one or more cannabinoid(s) one or more phospholipid(s) and optionally antioxidant(s), wherein said mixture is a liquid.
